(19) United States
(12) Patent Application Publication
(10) Pub. No.: US 2016/0363372 A1
(43) Pub. Date: Dec. 15, 2016

(54) METHOD FOR CONTROLLING DEW POINT OF REDUCTION FURNACE, AND REDUCTION FURNACE

(71) Applicant: JFE STEEL CORPORATION, Tokyo (JP)

(72) Inventors: Gentaro Takeda, Fukuyama (JP); Hideyuki Takahashi, Fukuyama (JP); Masaru Miyake, Fukuyama (JP); Yoichi Makimizu, Fukuyama (JP); Yoshitsugu Suzuki, Chiba (JP)

(73) Assignee: JFE STEEL CORPORATION, Tokyo (JP)

(21) Appl. No.: 15/119,022

(22) PCT Filed: Feb. 18, 2015
(86) PCT No.: PCT/JP2015/000742

§ 371 Date: Aug. 15, 2016

(30) Foreign Application Priority Data
Feb. 25, 2014 (JP) 2014-034270

(51) Int. Cl. F27D 7/02; C23C 2/40; C21D 9/00; C21D 9/46; C21D 1/26; C23C 2/06; C23C 2/28

(52) U.S. Cl. CPC F27D 7/02; C23C 2/06; C23C 2/40; C23C 2/28; C21D 9/46; C21D 1/26; C21D 9/0012; F27D 2019/0028

(57) ABSTRACT

Provided are a method for controlling a dew point in a reducing furnace and a reducing furnace in which, even in the case of galvanizing Si-added steel, coating adhesion can be secured, alloying treatment can be performed without increasing the alloying temperature excessively, and it is possible to obtain a hot-dip galvanized steel sheet having an excellent coating appearance. When a steel sheet is subjected to annealing and hot-dip galvanizing treatment using continuous hot-dip galvanizing equipment including at least a radiant tube-type reducing furnace, a mixed gas of a dry gas and a humidified gas by a humidifying device having a water vapor permeable membrane is used as a gas to be supplied into the reducing furnace. The mixed gas is supplied into the reducing furnace, thereby controlling the dew point in the reducing furnace.

### CROSS-REFERENCE TO RELATED APPLICATIONS

This is the U.S. National Phase application of PCT/JP2015/000742, filed Feb. 18, 2015, which claims priority to Japanese Patent Application No. 2014-034270, filed Feb. 25, 2014, the disclosures of each of these applications being incorporated herein by reference in their entireties for all purposes.

### FIELD OF THE INVENTION

The present invention relates to a method for controlling the dew point in a reducing furnace, and a reducing furnace.

### BACKGROUND OF THE INVENTION

In recent years, there has been an increase in the demand for high-tensile strength steel sheets (high-tensile strength steel) that can be used, for example, to reduce weight of structures in the fields of automobiles, home electrical appliances, building materials, and the like. Regarding the high-tensile strength steel, it is known that it is possible to obtain steel sheets which have good hole expandability, for example, by incorporating Si into steel, and steel sheets in which the retained y is easily formed and which have good ductility by incorporating Si and Al.

However, when a hot-dip galvanized steel sheet or a hot-dip galvannealed steel sheet is manufactured using, as a base material, a high-strength steel sheet containing a large amount of Si, the following problems arise. A method for a hot-dip galvanized steel sheet involves annealing with heating at a temperature of about 600° C. to 900° C. steel sheet in a non-oxidizing atmosphere or in a reducing atmosphere, followed by applying the steel sheet with hot-dip galvanizing treatment. However, Si, which is an easily oxidizable element, in the steel is selectively oxidized even in the non-oxidizing atmosphere or reducing atmosphere that is commonly used, and becomes concentrated on the surface to form an oxide. The oxide decreases wettability with molten zinc during coating treatment, resulting in the occurrence of bare spots. Therefore, wettability rapidly decreases with an increase in the Si concentration in the steel, and bare spots often occur. Furthermore, even if bare spots are not formed, there is a problem of poor coating adhesion. Moreover, when Si in the steel is selectively oxidized and becomes concentrated on the surface, a marked alloying delay occurs in the alloying process subsequent to hot-dip galvanizing. As a result, productivity is significantly hindered. When alloying treatment is performed at an excessively high temperature in order to secure productivity, a problem arises in which anti-powdering properties degrade. Thus, it is difficult to achieve both high productivity and good anti-powdering properties.

In view of these problems, for example, Patent Literatures 1 and 2 each disclose a method involving oxidizing the surface of a steel sheet using a direct fired furnace (DFF) or a non-oxidation furnace (NOF), and then, performing reduction in a reducing zone so that Si is internally oxidized and surface segregation of Si is suppressed, thereby improving hot-dip galvanizing wettability and adhesion.

Furthermore, Patent Literature 3 discloses a method involving humidifying a supply gas by passing the gas through warm water, dividing and controlling a furnace by sealing devices, and controlling H₂ concentration and a dew point in an annealing furnace to be in predetermined ranges so that Si is internally oxidized, thereby improving hot-dip galvanizing wettability and adhesion.

Patent Literature 4 discloses a method involving directly injecting water vapor into a heating furnace to adjust a dew point.

### CITATION LIST

### Patent Literature

PTL 1: Japanese Patent Application Publication No. 2010-202959

PTL 2: Japanese Patent Application Publication No. 2011-117069

PTL 3: WO2007/043273

PTL 4: Japanese Patent Application Publication No. 2005-264305

### SUMMARY OF THE INVENTION

However, the method described in each of Patent Literatures 1 and 2 arise a problem that there are decreases of tensile strength and ductility of a steel sheet, although coating adhesion after reduction is good, because the amount of internal oxidation is likely to be insufficient, and alloying temperature becomes 30° C. to 50° C. higher than usual under the influence of Si contained in the steel. If the amount of oxidation is increased in order to secure a sufficient amount of internal oxidation, the pick-up phenomenon, in which oxide scale adheres to in-furnace rolls and pressed-in flaws occur in the steel sheet, will occur. Therefore, it is not possible to use a method for simply increasing the amount of oxidation.

It is difficult for the method described in Patent Literature 3 to stably control a dew point within an optimum range, because when amount of water introduced into the furnace changes because of the change in the outside air temperature or the type of steel sheet, the dew point of the humidified gas is likely to be changed by this change.

It is known that the method described in Patent Literature 4 arises pick-up phenomenon. The pick-up phenomenon is that, when water vapor is directly supplied into the furnace, a region in which the dew point increases to 10° C. or higher occurs locally, and when a steel sheet passes through the region, even the base steel is oxidized.

Under the circumstances described above, it is an object of the present invention to provide a method for controlling the dew point in a reducing furnace and a reducing furnace in which, it is possible to secure coating adhesion and to perform alloying treatment without increasing the alloying temperature excessively even in the case of galvanizing Si-added steel and it is possible to obtain a hot-dip galvanized steel sheet having an excellent coating appearance.

The gist of the present invention for solving the problems described above includes the following aspects:
[1] A method for controlling a dew point in a reducing furnace which is at least a radiant tube-type and which is provided in continuous hot-dip galvanizing equipment, the method includes steps of: applying annealing and hot-dip galvanizing treatment to a steel sheet in the continuous hot-dip galvanizing equipment; and supplying a gas into the reducing furnace in the applying to control the dew point in the reducing furnace, by using a mixed gas of a dry gas and a humidified gas by a humidifying device having a water vapor permeable membrane as the gas to be supplied into the reducing furnace.
[2] The method stated in [1] above, wherein the dew point in the reducing furnace is controlled to −20° C. to 0° C.
[3] A reducing furnace which is a part of continuous hot-dip galvanizing equipment, the reducing furnace includes: a humidifying device having a water vapor permeable membrane and configured to humidify part of a dry gas to be supplied into the reducing furnace; a circulating constant temperature water tank configured to supply to the humidifying device water that is controlled to a predetermined temperature and that has a predetermined flow rate; a gas mixing device configured to mix the humidified gas by the humidifying device with a dry gas; a gas supply pipe configured to supply a gas mixed by the gas mixing device into the reducing furnace; and a supply gas dew point meter that measures the dew point of the gas to be supplied into the reducing furnace. [4] The reducing furnace stated in [3] above, further including a gas distributing device configured to distribute a part of the dry gas to be supplied into the reducing furnace to the humidifying device and supply the rest of the dry gas to the gas mixing device. [5] The reducing furnace stated in [3] or [4] above, wherein the humidifying device has a pipe through which the gas after humidification passes, and the pipe is maintained at a temperature equal to or higher than the dew point of the gas after humidification.

According to the present invention, since the dew point in a reducing furnace can be controlled with high accuracy, even in the case of steel containing 0.1% by mass or more of Si, it is possible to stably manufacture a hot-dip galvanized steel sheet having a beautiful surface appearance without a decrease in productivity. Furthermore, it is possible to manufacture a hot-dip galvanized steel sheet with high stability without being affected by disturbance, such as the air temperature or weather.

### BRIEF DESCRIPTION OF THE DRAWINGS

FIG. 1 is a diagram showing one example of continuous hot-dip galvanizing equipment according to an embodiment of the present invention.

FIG. 2 is a diagram showing one example of the inside of a reducing furnace according to an embodiment of the present invention.

FIG. 3 is a diagram showing a bubbling-type humidifying device.

FIG. 4 is a graph showing changes in the dew point in the middle portion of a reducing zone with time.

### DETAILED DESCRIPTION OF EMBODIMENTS OF THE INVENTION

The embodiments of the present invention will be specifically described below.

Annealing and hot-dip galvanizing treatment is applied to a steel sheet to manufacture a hot-dip galvanized steel sheet. An annealing furnace of continuous hot-dip galvanizing equipment is used to manufacture the hot-dip galvanized steel sheet. Types of the annealing furnace involve as follows, for example:

a heating furnace of the annealing furnace that heats a steel sheet is of direct fired furnace (DFF) type or non-oxidation furnace (NOF) type, and a soaking furnace of the annealing furnace that soaks the heated steel sheet is of radiant tube (RTF) type; and

an all radiant tube-type annealing furnace in which all portions from a heating furnace to a soaking furnace are provided with radiant tubes.

The present invention refers to a furnace portion provided with radiant tubes as the reducing furnace. That is, the soaking furnace is defined as the reducing furnace in case of an annealing furnace of which a heating furnace is of direct fired furnace (DFF) type or non-oxidation furnace (NOF) type and a soaking furnace is of radiant tube (RTF) type. The reducing furnace is defined to include portions from the heating furnace to the soaking furnace in case of an all radiant tube-type annealing furnace in which all portions from a heating furnace to a soaking furnace are provided with radiant tubes.

The method for controlling a dew point in a reducing furnace according to the present invention makes it possible to control the dew point in the reducing furnace with high accuracy in case of either the annealing furnace in which the heating furnace is of direct fired furnace (DFF) type or non-oxidation furnace (NOF) type and the soaking furnace is of radiant tube (RTF) type, or the all radiant tube-type annealing furnace. Further, the method makes it possible to secure coatability even in the case of a steel sheet containing large amounts of easily oxidizable elements, such as Si, in any type of the annealing furnace.

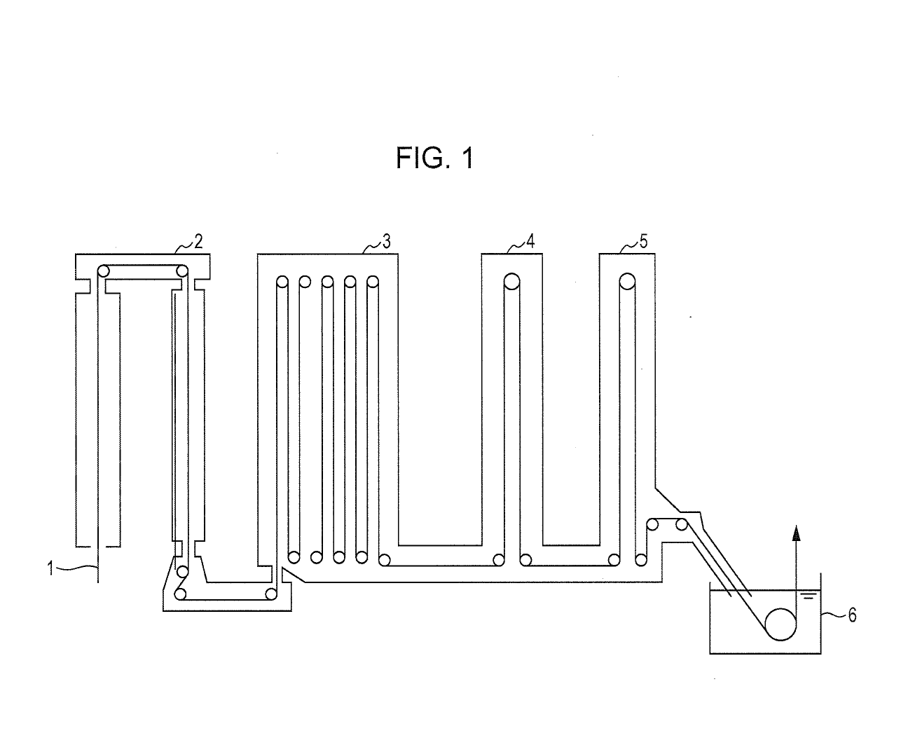

FIG. 1 is a diagram showing an example of a structure of continuous hot-dip galvanizing equipment including an annealing furnace and a coating device. In FIG. 1, reference sign 1 denotes a steel sheet, reference sign 2 denotes a direct fired furnace-type heating zone (DFF), reference sign 3 denotes a reducing furnace (radiant tube type), reference sign 4 denotes a quenching zone, reference sign 5 denotes a slow cooling zone, and reference sign 6 denoted a coating device.

The steel sheet 1 is heated in the direct fired furnace-type heating zone (DFF) 2 (oxidation treatment step), subsequently reduced in the reducing furnace 3 (reduction annealing step), then cooled in the quenching zone 4 and the slow cooling zone 5 (cooling step), and subjected to coating (galvanizing) treatment in the coating device 6.

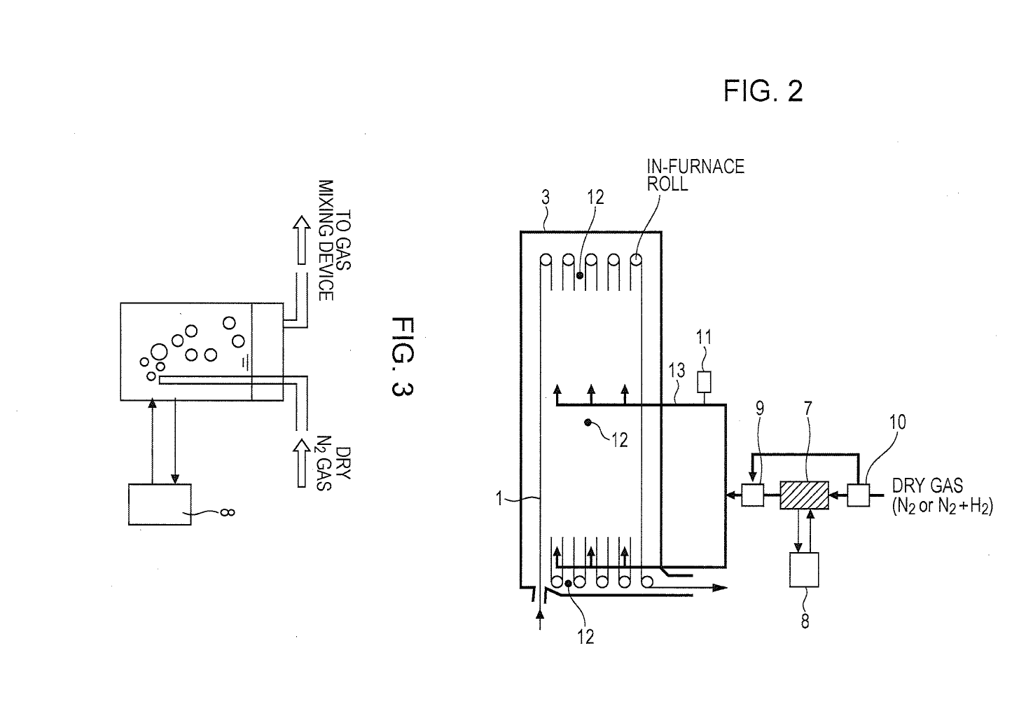

FIG. 2 is a diagram showing the structure of the reducing furnace 3 shown in FIG. 1 and a reducing furnace according to an embodiment of the present invention. FIG. 2 shows a supply route of a gas to be supplied into the furnace in the reducing furnace (radiant tube type) 3. In FIG. 2, reference sign 7 denotes a humidifying device, reference sign 8 denotes a circulating constant temperature water tank, reference sign 9 denotes a gas mixing device, reference sign 10 denotes a gas distributing device, reference sign 11 denotes a supply gas dew point meter, reference sign 12 denotes a dew point collecting point in the furnace (3 points), and reference sign 13 denotes a gas supply pipe.

Referring to FIG. 2, part of the gas (dry gas) to be supplied into the reducing furnace is distributed by the gas distributing device 10, as a gas for humidification, to the humidifying device 7, and the rest of the dry gas is sent to the gas mixing device 9. The gas is N₂ gas or a mixture of N₂ gas and H₂ gas.

Water preferably pure water is sent to the humidifying device 7 at the same time when the gas is sent. The gas for humidification is distributed by the gas distributing device 10 and the water is controlled to a predetermined temperature at a predetermined flow rate by the circulating constant temperature water tank 8.

The humidifying device 7 includes a humidifying module having, as a water vapor permeable membrane, a hollow fiber membrane, a flat membrane, or the like made of a fluorinated resin or polyimide. The gas for humidification distributed by the gas distributing device 10 flows inside the membrane, and water adjusted to a predetermined temperature in the circulating constant temperature water tank 8 flows and circulates outside the membrane.

The hollow fiber membrane or flat membrane made of a fluorinated resin or polyimide is an ion exchange membrane having an affinity for water molecules. When there occurs a difference in the concentration of water between the inside and outside of the hollow fiber membrane (flat membrane), a force that tries to equalize the difference in the concentration is generated, and using this force as a driving force, water permeates and moves toward the side having a lower water concentration. Thereby, the gas for humidification becomes a gas which is humidified so as to have a dew point that is the same as the temperature of water circulating outside the membrane.

The gas humidified by the humidifying device 7 is mixed with the dry gas sent by the gas distributing device 10 in the gas mixing device 9, and the mixed gas is supplied as a gas to be supplied into the reducing furnace, i.e., a supply gas, into the reducing furnace through the gas supply pipe 13.

Three in-furnace dew point collection points 12 are set up inside the reducing furnace, and the dew points inside the reducing furnace are measured. In response to the measurement results, while monitoring the supply gas dew point meter 11, the supply gas dew point and flow rate are controlled in appropriate ranges so that the dew points inside the reducing furnace are adjusted in desired ranges.

Conventionally, a dry N₂ gas or mixed gas of N₂ and H₂ with a dew point of −60° C. to −40° C. is constantly supplied into the reducing furnace 3. In contrast, an aspect of the present invention involves humidifying part of the dry gas by the humidifying device 7; mixing the humidified gas with the dry gas in the gas mixing device 9 such that the mixed gas is adjusted to have a predetermined dew point; and then supplying the resulting gas into the reducing furnace 3. The dry gas temperature changes depending on the season and/or temperature changing during a day. However, the present invention performs heat exchange with securing a sufficient contact area between the gas and water through the water vapor permeable membrane, so that the resulting humidified gas has a dew point that is the same as the set temperature of water even when the dry gas temperature prior to the humidifying device is higher or lower than the temperature of circulating water. Therefore, the gas temperature is not influenced by the season and the temperature changing during a day. It is possible to control the dew point with high accuracy. The humidified gas can be arbitrarily controlled in a range of 0° C. to 50° C.

In the reducing furnace 3, when the dew point increases to +10° C. or higher, the base steel of the steel sheet starts to be oxidized. Therefore, the dew point of the gas to be supplied into the reducing furnace 3 is preferably lower than +10° C. Furthermore, from the viewpoint of uniformity of the distribution of dew points inside the reducing furnace and for the reason of minimizing the dew point fluctuation range, the dew point of the gas is preferably 0° C. or lower.

When the dew point of the gas supplied into the furnace is higher than the outside air temperature around the pipe, there is a possibility that dew condensation will occur in the pipe and the condensed water will directly enter the furnace. Consequently, the pipe through which the gas to be supplied into the furnace passes is preferably heated and maintained at a temperature that is equal to or higher than the dew point of the gas after humidification.

In FIG. 2, three in-furnace dew point collection points 12 are set up, and the dew point are measured at a plurality of points, i.e., three points in the upper portion, lower portion, and middle portion in the height direction of the reducing furnace 3. In the case where gas components includes N₂ and H₂O in the reducing furnace, H₂O has a low specific gravity relative to N₂ which usually occupies 40% to 95% by volume and is likely to remain in the upper portion of the reducing furnace 3, and the dew point tends to be high in the upper portion of the reducing furnace 3. As described above, since the problem of pick-up or the like occurs at a dew point of +10° C. or higher, it is important to measure the dew point in the upper portion of the reducing furnace 3 in terms of controlling the upper limit of the dew point in the reducing furnace 3. On the other hand, it is important to measure the dew point in the middle portion of the reducing furnace 3 and the lower portion of the reducing furnace 3 in terms of controlling the dew point in the region with which most of the steel sheet is brought into contact. It is preferable to determine the dew point of the gas supplied into the reducing furnace 3 by controlling the dew point at three or more points in the upper portion, lower portion, and middle portion in the height direction of the reducing furnace 3 in such a manner.

According to explanation with reference to FIGS. 1 and 2, since the dew point can be controlled with high accuracy in the reducing furnace (reduction annealing step), in the reduction annealing step, the iron oxide formed on the surface of the steel sheet in the oxidation treatment step is reduced, and alloy elements, such as Si and Mn, are formed as internal oxides inside the steel sheet by oxygen supplied from the iron oxide. As a result, a reduced iron layer reduced from the iron oxide is formed on the outermost surface of the steel sheet, and Si and Mn remain as internal oxides inside the steel sheet. Therefore, oxidation of Si and Mn on the surface of the steel sheet is suppressed, the decrease in wettability between the steel sheet and hot dipping is prevented, and it is possible to obtain good coating adhesion without bare spots.

However, although good coating adhesion is obtained, since the alloying temperature in a Si-containing steel increases to a high temperature, there may be a case where the retained austenite phase is decomposed into the pearlite phase, or the martensite phase is tempered and softened, and therefore, it is not possible to obtain desired mechanical properties. Accordingly, as a result of studies on a technique for decreasing the alloying temperature, inventors have developed a technique for accelerating the alloying reaction by actively forming internal oxidation of Si to decrease the amount of solute Si in the surface layer of the steel sheet. In order to further actively form internal oxidation of Si, it is effective to control the dew point of the atmosphere in the annealing furnace to −20° C. or higher.

When the dew point in the reduction annealing furnace is controlled to −20° C. or higher, even after oxygen is supplied from the iron oxide to form the internal oxide of Si, internal oxidation of Si is continuously caused by oxygen supplied from H₂O in the atmosphere. Therefore, a larger amount of internal oxidation of Si is formed. Consequently, the amount of solute Si decreases in the internal region of the surface layer of the steel sheet in which internal oxidation is formed. When the amount of solute Si decreases, the surface layer of the steel sheet behaves like low-Si steel, the subsequent alloying reaction is accelerated, and the alloying reaction proceeds at a low temperature. As a result of the decrease in the alloying temperature, ductility improves because a high fraction of the retained austenite phase can be maintained, and a desired strength can be obtained because tempering and softening of the martensite phase do not proceed. In the reducing furnace 3, when the dew point increases to +10° C. or higher, the base steel of the steel sheet starts to be oxidized. Therefore, from the viewpoint of uniformity of the distribution of dew points inside the reducing furnace and for the reason of minimizing the dew point fluctuation range, the upper limit is preferably controlled at 0° C.

### EXAMPLE 1

In continuous hot-dip galvanizing equipment including a direct fired furnace (DFF) type heating furnace and a radiant tube (RTF) type soaking furnace, steel sheets having the compositions shown in Table 1 were subjected to annealing and hot-dip galvanizing treatment. Subsequently, by performing alloying treatment, hot-dip galvannealed steel sheets were produced.

In the heating furnace, a DFF in which heating burners were divided into four groups (#1 to #4) was used. The three groups (#1 to #3) at the upstream side in the steel sheet travelling direction (first stage) were defined as an oxidation zone, and the final zone (#4) (second stage) was defined as a reduction zone. The air ratio in each of the oxidation zone and the reduction zone was individually controlled. Note that the length of each zone was 4 m.

As a soaking furnace, the reducing furnace shown in FIG. 2 was used. The humidifying device was a polyimide hollow fiber membrane-type humidifying device. As shown in FIG. 2, the gas after humidification and the dry gas were mixed and then supplied into the reducing furnace. Supply gas supply ports were provided at three points in the lower portion of the furnace and at three points in the middle portion of the furnace as shown in FIG. 2.

The hollow fiber membrane-type humidifying device included 10 membrane modules, and a N₂+H₂ mixed gas at maximum 500 L/min and circulating water at maximum 10 L/min were made to flow in each module. In the N₂+H₂ mixed gas, the composition was adjusted in advance for injection into the reducing furnace, and the dew point was constant at −50° C. However, since the pipe leading to the reducing furnace is changed by the outside air temperature, the gas temperature changes depending on the outside air temperature. Accordingly, the pipe was kept at a temperature equal to or higher than the dew point of the gas after humidification. The circulating constant temperature water tank is capable of supplying pure water at 100 L/min in total.

The other production conditions are shown in Table 2. The galvanizing bath temperature was set at 460° C., the Al concentration in the galvanizing bath was set at 0.130%, and the coating weight was adjusted to 45 g/m² per surface by gas wiping. Regarding the alloying temperature, alloying treatment was performed in an induction heating-type alloying furnace such that the degree of alloying in the coating (Fe content) was 10% to 13%.

For comparison, an existing bubbling-type humidifying device (FIG. 3) was used as a soaking furnace. In the bubbling type, the same amounts of gas and circulating water were mixed and humidified in one water tank. The conditions other than the humidifying device were the same as those in the examples described above.

Regarding the hot-dip galvannealed steel sheets thus obtained, the coating appearance and the material strength were evaluated.

In the evaluation of the coating appearance, inspection with an optical surface defect detector (detection of bare spots with a diameter of 0.5 mm or more and peroxidation defects) and visual determination of uneven alloying were performed. When all the items passed, the evaluation was marked with A, and when even one of the items failed, the evaluation was marked with C.

The material strength was evaluated in terms of tensile strength. A tensile strength of 590 MPa or more in steel type A, a tensile strength of 780 MPa or more in steel type B, and a tensile strength of 1,180 MPa or more in steel type C were evaluated as passed.

Note that, in Table 2, Nos. 1 to 12 show the results in winter, and Nos. 13 to 24 show the results in summer. The results obtained as described above together with the conditions are shown in Table 2. The time in the table indicates the operation's elapsed time, and Nos. 1 and 13 show the results at the time when the existing bubbling-type humidifying device was switched to the humidifying device having the water vapor permeable membrane. Furthermore, after 1 hour 30 minutes from the start of the operation, the humidifying device was switched again to the existing bubbling-type humidifying device.

TABLE 1
(mass %)

| Steel type | C | Si | Mn | P | S |
|---|---|---|---|---|---|
| A | 0.08 | 0.25 | 1.5 | 0.03 | 0.001 |
| B | 0.12 | 1.4 | 1.9 | 0.01 | 0.001 |
| C | 0.15 | 2.1 | 2.8 | 0.01 | 0.001 |

TABLE 2

| | | | Heating zone (DFF) | | | Reducing zone (RTF) | | | | |
|---|---|---|---|---|---|---|---|---|---|---|
| | | | | | DFF | | | Middle | | |
| | | | First | Second | exit side | H₂ | Upper portion | portion dew | Lower portion | Heating |
| | Time | Steel | stage air | stage air | temperature | concentration | dew point | point | dew point | temperature |
| No. | (min) | type | ratio | ratio | (° C.) | (%) | (° C.) | (° C.) | (° C.) | (° C.) |
| 1 | 0:00 | A | 0.95 | 0.85 | 682 | 15 | −30.5 | −34.6 | −40.7 | 801 |
| 2 | 0:15 | A | 0.95 | 0.85 | 683 | 15 | −15.7 | −16.5 | −19.2 | 805 |
| 3 | 0:30 | C | 1.15 | 0.85 | 747 | 15 | −12.3 | −13.2 | −16.1 | 830 |
| 4 | 0:45 | C | 1.20 | 0.85 | 751 | 15 | −11.1 | −12.0 | −14.9 | 831 |
| 5 | 1:00 | B | 1.15 | 0.85 | 718 | 15 | −12.5 | −14.4 | −16.3 | 830 |
| 6 | 1:15 | B | 1.10 | 0.85 | 719 | 15 | −12.4 | −14.2 | −15.9 | 830 |
| 7 | 1:30 | A | 0.95 | 0.85 | 680 | 15 | −11.1 | −13.0 | −14.8 | 801 |
| 8 | 1:45 | A | 0.95 | 0.85 | 682 | 15 | −18.3 | −21.8 | −25.2 | 805 |
| 9 | 2:00 | C | 1.15 | 0.85 | 752 | 15 | −28.3 | −32.0 | −35.6 | 830 |
| 10 | 2:15 | C | 1.20 | 0.85 | 751 | 15 | −31.5 | −37.1 | −42.7 | 831 |
| 11 | 2:30 | B | 1.15 | 0.85 | 722 | 15 | −26.2 | −30.8 | −35.3 | 832 |
| 12 | 2:45 | B | 1.10 | 0.85 | 719 | 15 | −28.3 | −32.8 | −37.2 | 829 |
| 13 | 0:00 | A | 0.95 | 0.85 | 679 | 15 | −8.2 | −9.3 | −12.3 | 801 |
| 14 | 0:15 | A | 0.95 | 0.85 | 683 | 15 | −10.3 | −10.8 | −13.2 | 805 |
| 15 | 0:30 | C | 1.15 | 0.85 | 752 | 15 | −11.3 | −11.9 | −14.5 | 830 |
| 16 | 0:45 | C | 1.20 | 0.85 | 753 | 15 | −12.1 | −13.0 | −15.9 | 831 |
| 17 | 1:00 | B | 1.15 | 0.85 | 722 | 15 | −12.9 | −14.9 | −16.8 | 830 |
| 18 | 1:15 | B | 1.10 | 0.85 | 720 | 15 | −12.6 | −14.4 | −16.2 | 830 |
| 19 | 1:30 | A | 0.95 | 0.85 | 679 | 15 | −11.3 | −12.8 | −14.2 | 801 |
| 20 | 1:45 | A | 0.95 | 0.85 | 682 | 15 | −1.7 | −3.5 | −5.3 | 805 |
| 21 | 2:00 | C | 1.15 | 0.85 | 753 | 15 | 0.9 | −1.2 | −3.3 | 830 |
| 22 | 2:15 | C | 1.20 | 0.85 | 748 | 15 | 2.5 | 0.7 | −1.2 | 831 |
| 23 | 2:30 | B | 1.15 | 0.85 | 719 | 15 | 4.0 | 1.7 | −0.7 | 832 |
| 24 | 2:45 | B | 1.10 | 0.85 | 722 | 15 | 6.2 | 3.9 | 1.5 | 829 |

| | | | | Alloying | | | |
|---|---|---|---|---|---|---|---|
| | Reducing zone (RTF) | | Outside air | treatment | | | |
| | | Gas dew point | temperature | Alloying | | Tensile | |
| | | after | Outside air | temperature | Coating | strength | |
| No. | Humidifying method | humidification | temperature | (° C.) | appearance | MPa | |
| 1 | Bubbling | −15° C. | 5° C. | 552 | B | 575 | Comparative Example |
| 2 | Hollow fiber membrane | 10° C. | 5° C. | 520 | A | 622 | Example |
| 3 | Hollow fiber membrane | 10° C. | 5° C. | 515 | A | 1260 | Example |
| 4 | Hollow fiber membrane | 10° C. | 5° C. | 513 | A | 1233 | Example |
| 5 | Hollow fiber membrane | 10° C. | 5° C. | 517 | A | 802 | Example |
| 6 | Hollow fiber membrane | 10° C. | 5° C. | 516 | A | 811 | Example |
| 7 | Hollow fiber membrane | 10° C. | 5° C. | 514 | A | 625 | Example |
| 8 | Bubbling | −15° C. | 5° C. | 529 | B | 592 | Comparative Example |
| 9 | Bubbling | −12° C. | 5° C. | 587 | C | 1152 | Comparative Example |
| 10 | Bubbling | −7° C. | 5° C. | 597 | C | 1101 | Comparative Example |
| 11 | Bubbling | −5° C. | 5° C. | 575 | B | 760 | Comparative Example |
| 12 | Bubbling | −5° C. | 5° C. | 579 | B | 771 | Comparative Example |
| 13 | Bubbling | 16° C. | 35° C. | 509 | B | 621 | Comparative Example |
| 14 | Hollow fiber membrane | 10° C. | 35° C. | 511 | A | 620 | Example |
| 15 | Hollow fiber membrane | 10° C. | 35° C. | 513 | A | 1250 | Example |
| 16 | Hollow fiber membrane | 10° C. | 35° C. | 514 | A | 1245 | Example |
| 17 | Hollow fiber membrane | 10° C. | 35° C. | 517 | A | 798 | Example |
| 18 | Hollow fiber membrane | 10° C. | 35° C. | 517 | A | 805 | Example |
| 19 | Hollow fiber membrane | 10° C. | 35° C. | 514 | A | 618 | Example |
| 20 | Bubbling | 23° C. | 35° C. | 500 | B | 610 | Comparative Example |
| 21 | Bubbling | 25° C. | 35° C. | 497 | B | 1253 | Comparative Example |
| 22 | Bubbling | 26° C. | 35° C. | 504 | C | 1255 | Comparative Example |
| 23 | Bubbling | 27° C. | 35° C. | 502 | C | 802 | Comparative Example |
| 24 | Bubbling | 29° C. | 35° C. | 502 | C | 797 | Comparative Example |

As shown in Table 2, in the case of winter, in Nos. 2 to 7 which are examples of the present invention, since it was possible to stably control the dew point in the furnace in a range of −10° C. to −20° C., both the surface appearance and the material strength were evaluated as passed. In contrast, in No. 1 and Nos. 8 to 12 (comparative examples) in which the existing bubbling method was used, since the gas temperature prior to the humidifying device was low and it was not possible to perform heat exchange sufficiently even though bubbling was performed, the dew point did not increase, and it was not possible to increase the dew point in the furnace. As a result, the alloying temperature increased, and it was not possible to secure the target tensile strength. There was also a problem with dew point stability.

In the case of summer, in Nos. 14 to 19 (examples of the present invention), since it was possible to stably control the dew point in the furnace in a range of −10° C. to −20° C., both the surface appearance and the material strength were evaluated as passed. In No. 13 and Nos. 20 to 24 (comparative examples) in which the existing bubbling method was used, since the gas temperature did not decrease sufficiently, the gas dew point after humidification was in a very high state, and therefore, the dew point was excessively increased. As a result, although the alloying temperature was decreased, uneven alloying became easily noticeable. In Nos. 21 to 24 in which the dew point exceeded 0° C., pressed-in flaws due to the pick-up occurred.

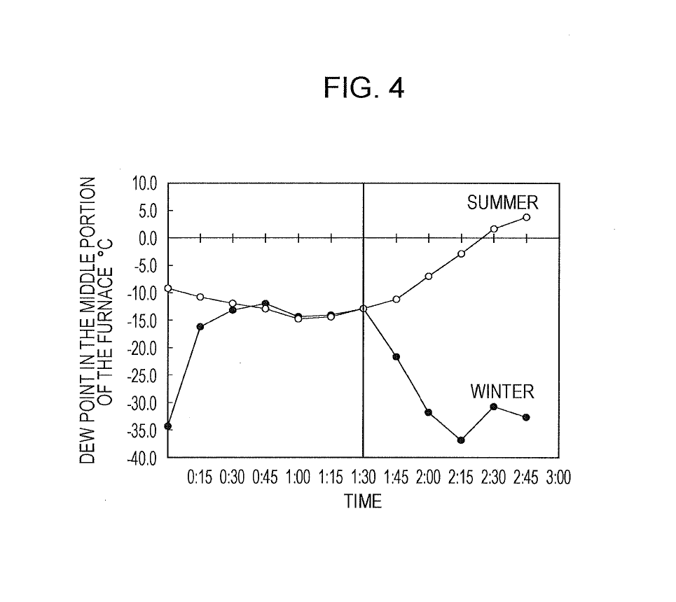

FIG. 4 shows changes in the dew point with relation to the time and the dew point in the middle portion of the reducing zone shown in Table 2. In FIG. 4, time: 0 min indicates switching from the bubbling-type humidifying device to the humidifying device having the water vapor permeable membrane, and time: 1 hr 30 min indicates switching again to the existing bubbling-type humidifying device. As is evident from FIG. 4, in the examples of the present invention, regardless of summer or winter, it is possible to control to a desired dew point in a short period of time.

### REFERENCE SIGNS LIST

1 steel sheet
   2 direct fired furnace-type heating zone (DFF)
   3 reducing furnace (radiant tube type)
   4 quenching zone
   5 slow cooling zone
   6 coating device
   7 humidifying device
   8 circulating constant temperature water tank
   9 gas mixing device
   10 gas distributing device
   11 supply gas dew point meter
   12 in-furnace dew point collection point (3 points)
   13 gas supply pipe

1. A method for controlling a dew point in a reducing furnace which is at least a radiant tube-type and which is provided in continuous hot-dip galvanizing equipment, the method comprising steps of:
applying annealing and hot-dip galvanizing treatment to a steel sheet in the continuous hot-dip galvanizing equipment; and
supplying a gas into the reducing furnace in the applying to control the dew point in the reducing furnace, by using a mixed gas of a dry gas and a humidified gas by a humidifying device having a water vapor permeable membrane as the gas to be supplied into the reducing furnace.

2. The method according to claim 1, wherein the dew point in the reducing furnace is controlled to −20° C. to 0° C.

3. A reducing furnace which is a part of continuous hot-dip galvanizing equipment, the reducing furnace comprising:
a humidifying device having a water vapor permeable membrane and configured to humidify part of a dry gas to be supplied into the reducing furnace;
a circulating constant temperature water tank configured to supply to the humidifying device water that is controlled to a predetermined temperature and that has a predetermined flow rate;
a gas mixing device configured to mix the humidified gas by the humidifying device with a dry gas;
a gas supply pipe configured to supply a gas mixed by the gas mixing device into the reducing furnace; and
a supply gas dew point meter that measures the dew point of the gas to be supplied into the reducing furnace.

4. The reducing furnace according to claim 3, further comprising:
a gas distributing device configured to distribute a part of the dry gas to be supplied into the reducing furnace to the humidifying device and supply the rest of the dry gas to the gas mixing device.

5. The reducing furnace according to claim 3, wherein,
the humidifying device has a pipe through which the gas after humidification passes, and
the pipe is maintained at a temperature equal to or higher than the dew point of the gas after humidification.

6. The reducing furnace according to claim 4, wherein,
the humidifying device has a pipe through which the gas after humidification passes, and
the pipe is maintained at a temperature equal to or higher than the dew point of the gas after humidification.
